(19) United States
(12) Patent Application Publication
(10) Pub. No.: US 2019/0335947 A1
(43) Pub. Date: Nov. 7, 2019

(54) COOKING DEVICE

(71) Applicant: Archimedes Perdios, NEW YORK, NY (US)

(72) Inventor: Archimedes Perdios, NEW YORK, NY (US)

(21) Appl. No.: 16/512,147

(22) Filed: Jul. 15, 2019

(51) Int. Cl. A47J 37/04

(52) U.S. Cl. CPC A47J 37/045

(57) ABSTRACT

Embodiment herein discloses a cooking device for adapting belt grill technology to the fast food industry wherein food products can be cooked rapidly and efficiently by placing the food products at one end of a conveyor belt whereby the food products are cooked and then expelled at the other/opposite end of the conveyor belt. Further, the conveyor belt is provided with teeth like structures for facilitating rotation of the food product resulting in uniform cooking of the food product.

### BACKGROUND

### Technical Field

This invention relates in general to cooking device and, in particular, to such device or apparatus which performs uniform and rapid cooking and, in more particular to such device or apparatus which performs uniform and rapid cooking of large quantities of food such as fast foods.

### Description of the Related Art

Mass cooking using belt cooking devices have been in use for processing food products such as hamburgers and other meat patties, chicken and fish filets, pancakes, sandwiches, and other foods. Cooking is achieved by heat conduction to the food product as it is conveyed through heated platens. Typically, a belt grill uses upper and lower platens arranged in parallel planes which are heated by conventional means such as electricity, gas or the like. The uncooked food is fed onto the belt at one end and the cooked product exits the device at the other end.

However, one limitation associated with the traditional belt cooking devices is absence of movement/rotation of the food product placed on the belt leading to non-uniform cooking of the food product. This in turn affects the taste of the cooked food product. Further, it may also affect the heath of users consuming such food.

The above mentioned shortcomings, disadvantages and problems are addressed herein and which will be understood by reading and studying the following specification.

### OBJECT OF THE EMBODIMENTS HEREIN

The primary object of the embodiments herein is to provide a belt cooking device which is suitable for fast food industry utilization wherein the food products are introduced into the cooking belt at one end and cooked food products extracted from the other/opposite end.

Another object of the embodiments herein is to provide a belt grill type cooking device for use in the fast food industry to provide a grill with teeth like structures or serrations which facilitate rotation of the food product within the belt grill type cooking device.

These and other objects and advantages of the embodiments herein will become readily apparent from the following summary and the detailed description taken in conjunction with the accompanying drawings.

### SUMMARY

The following details present a simplified summary of the embodiments herein to provide a basic understanding of the several aspects of the embodiments herein. This summary is not an extensive overview of the embodiments herein. It is not intended to identify key/critical elements of the embodiments herein or to delineate the scope of the embodiments herein. Its sole purpose is to present the concepts of the embodiments herein in a simplified form as a prelude to the more detailed description that is presented later.

The other objects and advantages of the embodiments herein will become readily apparent from the following description taken in conjunction with the accompanying drawings.

The various embodiments herein provide a conveyor belt system for cooking food products in a modular fashion.

According to an embodiment herein, a cooking device is described for adapting belt grill technology, e.g., in a fast food industry, wherein food products are required to be cooked rapidly and efficiently by placing the food products at one end of a conveyor belt system and extracted from the other (e.g., opposite) end.

These and other aspects of the embodiments herein will be better appreciated and understood when considered in conjunction with the following description and the accompanying drawings. It should be understood, however, that the following descriptions, while indicating preferred embodiments and numerous specific details thereof, are given by way of illustration and not of limitation. Many changes and modifications may be made within the scope of the embodiments herein without departing from the spirit thereof, and the embodiments herein include all such modifications.

### BRIEF DESCRIPTION OF THE DRAWINGS

The other objects, features and advantages will occur to those skilled in the art from the following description of the preferred embodiment and the accompanying drawings in which:

FIG. 1 illustrates a schematic diagram representing front view of a food cooking device, according to an embodiment herein.

Although the specific features of the embodiments herein are shown in some drawings and not in others. This is done for convenience only as each feature may be combined with any or all of the other features in accordance with the embodiment herein.

### DETAILED DESCRIPTION OF THE EMBODIMENTS HEREIN

The embodiments herein and the various features and advantageous details thereof are explained more fully with reference to the non-limiting embodiments that are illustrated in the accompanying drawings and detailed in the following description. Descriptions of well-known components and processing techniques are omitted so as to not unnecessarily obscure the embodiments herein. The examples used herein are intended merely to facilitate an understanding of ways in which the embodiments herein may be practiced and to further enable those of skill in the art to practice the embodiments herein. Accordingly, the examples should not be construed as limiting the scope of the embodiments herein.

In the following detailed description, a reference is made to the accompanying drawings that form a part hereof, and in which the specific embodiments that may be practiced is shown by way of illustration. The embodiments are described in sufficient detail to enable those skilled in the art to practice the embodiments and it is to be understood that the logical, mechanical and other changes may be made without departing from the scope of the embodiments. The following detailed description is therefore not to be taken in a limiting sense.

The invention described herein provides a conveyor belt system for cooking food products in a modular fashion.

According to an embodiment herein, there is described a cooking device for adapting belt grill technology to the fast food industry wherein a series of identical food products can be cooked rapidly and efficiently. The cooking process includes placing the food products at one end of a conveyor belt whereby the food products are cooked and then expelled at the other end of the conveyor belt. The conveyor belt is provided with multiple teeth like structures to facilitate rotation of the food products within the conveyor belt resulting in uniform cooking of the food product.

The conveyor belt may be heated by conventional means such as electricity, charcoal, gas or the like. The conveyor belt is configured to move/rotate making 360 degree over the heating media. The speed is controlled by a motor driving a chain positioned beneath the conveyor belt. The length of the conveyor belt is designed such that the time taken for movement of a food product, placed on one end of the conveyor belt to the other end where the food product is expelled, is sufficient to cook the food product.

Further, the conveyor belt is provided with a series of teeth like structures. Each series of teeth like structures comprises multiple teeth positioned in a longitudinal orientation such that the space between two series of teeth like structure is employed for placing the food product. The series of teeth are configured to be turned so as to facilitate rotational movement of the food product. This movement occurs through the entire length of the conveyor belt such that the uniformly cooked food product is expelled to a tray positioned at the other end of the conveyor belt. Further, the width of the conveyor belt is adjustable to accommodate variation in size of the food product being cooked.

In one exemplary embodiment, the present invention discloses a conveyor belt cooking device for cooking barbeque. The present invention discloses automatic cooking of food recipes/products/items on a conveyer belt barbeque system for cooking food recipes/products/items such as souvlaki, kebabs and the like. The meat is loaded on the sticks or small skewers and placed on top of the chain of the barbeque. The chain moves making a rotation of 360° on a heating medium. The heating medium is charcoal or a gas media. The speed of the chain and barbeque is controlled by a motor driven chain. By the time the chain or the spindle rotates and reaches the end, the food recipe/product/item such as meat is cooked.

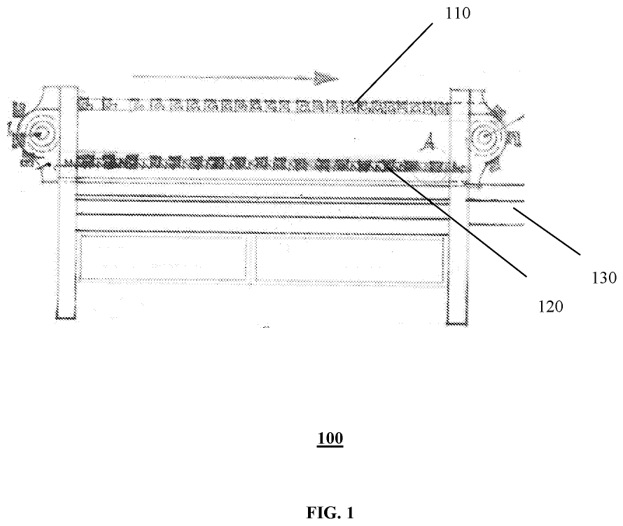

With attention to the drawings and to FIG. 1, the cooking device 100 includes a conveyor belt that carries the uncooked food product through the process of cooking. The conveyor belt of this invention includes an upper belt 110 and a lower belt 120. The belts 110 and 120 are preferably constructed of fiberglass covered or impregnated with Teflon. The conveyor belt conducts heat because of the thin cross section. Teflon is a good insulator. In addition, the conveyor belt is resistant to the accumulation of cooked or partially cooked food. The belts 110 and 120 are of conventional design and may be heated, for example, electrically. As shown in FIG. 1, the belts 110 and 120 rotate in opposite directions with food traveling from right to left as it cooks on the conveyor formed by said belts 110 and 120

Rotation of belts 110 and 120 is achieved by a drive system. The drive system is a chain drive of conventional design consisting of an endless chain driven by a gear motor for example.

The food product to be cooked is intended to travel through the cooking device 100 of this invention from the left to the right whereby cooked food exits on the ramp 130. The distance between the belts 110 and 120 can be regulated by a linear actuator to any desired distance. As will be obvious though, other conventional mechanical means may also be employed.

In summary, there is described herein a cooking device for adapting belt grill technology to the fast food industry wherein food products can be cooked rapidly and efficiently by placing the food products at one end of the conveyor belt whereby the food products are cooked and then expelled at the opposite end of the conveyor belt.

The advantages of the embodiments disclosed herein comprise uniform cooking of the food product placed on the conveyor belt and easy maintenance of the cooking device.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the spirit and scope of the appended claims.

Although the embodiments herein are described with various specific embodiments, it will be obvious for a person skilled in the art to practice the invention with modifications. However, all such modifications are deemed to be within the scope of the appended claims.

It is also to be understood that the following claims are intended to cover all of the generic and specific features of the embodiments described herein and all the statements of the scope of the embodiments which as a matter of language might be said to fall there between.

What is claimed is:

1. A cooking device comprising:
a conveyor belt for creating an elongated horizontal path of travel between a loading station and a discharge station, the conveyor belt including two or more endless belt drives spaced transversely from each other relative to the length of the elongated horizontal path;
a drive system operatively engaged to the belt drives for moving the belt drives along the elongated horizontal path of travel;
a heating unit for heating a food product positioned on the conveyor belt, the heating unit disposed along the elongated horizontal path of travel; and
wherein the conveyor belt comprises a series of teeth like structures configured to be turned so as to facilitate rotational movement of the food product.

2. The cooking device according to claim 1 further comprising a receiving unit for guiding and receiving the food product through landing at the discharge station.

3. The cooking device according to claim 1, wherein each series of teeth like structures comprise multiple teeth positioned in a longitudinal orientation such that the space between two series of teeth like structures is employed for placing the food product.

4. The cooking device according to claim 1, wherein the drive system is an electric motor driving a shaft engaged to multiple sprocket wheels turning the endless belts.

5. The cooking device according to claim 1, wherein the heating unit is an electrically operated coil.

6. The cooking device according to claim 1, wherein the conveyor belt includes a first and a second endless belt drive.
